(19) United States
(12) Patent Application Publication
(10) Pub. No.: US 2019/0024409 A1
(43) Pub. Date: Jan. 24, 2019

(54) Portable and Rechargeable Night Light for Illuminating Door Knobs

(71) Applicant: Koen Edgar Thomen, Colchester, CT (US)

(72) Inventor: Koen Edgar Thomen, Colchester, CT (US)

(21) Appl. No.: 15/978,108

(22) Filed: May 12, 2018

Related U.S. Application Data
(60) Provisional application No. 62/513,984, filed on Jun. 1, 2017.

(51) Int. Cl. E05B 17/10; F21S 9/02; E05B 1/00; F21V 33/00

(52) U.S. Cl. CPC E05B 17/10; F21S 9/02; F21Y 2115/10; F21V 33/0016; E05B 1/0007

(57) ABSTRACT

An embodiment of the invention includes an illuminating apparatus that is hung on a door knob. The purpose of the invention is to assist the discovery of the location in of the door knob in reduced lighting conditions.

### CROSS REFERENCE TO RELATED APPLICATION

This application claims priority to the previously filed provision application Ser. No. 62/513,984 filed on Jun. 1, 2017.

### BACKGROUND

### Field of the Invention

The present invention relates generally to the field of night lights and related illuminating apparatus, in particular, the invention herein is used with a door having a handle, and provides a means for illuminating the handle of the door.

### Description of the Related Art

There have been many attempts to provide illumination in dark rooms. Typically, these attempts provide a brightness that they may interrupt an ability of occupants of the rooms to sleep. Some night lights assist the user specifically to find the door. One example is U.S. Pat. No. 6,132,057, which may cause ocular discomfort of an occupant whom, with dilated eyes may direct their gaze to a white or bright light.

### SUMMARY

The invention is a night light that may be applied to hang on and illuminate a door knob.

### BRIEF DESCRIPTION OF THE DRAWINGS

FIG. 1 is a perspective view of the invention, shown being applied to a door knob.

FIG. 1a is a side view of FIG. 1.

FIG. 2 is a diagram depicting the construction and circuitry.

FIG. 3 depicts the folding motion of a folding embodiment of the invention.

FIG. 4 is a perspective view showing the use of the invention while being recharged.

FIG. 5 depict the use of the invention to charge a small electronic devise

### DETAILED DESCRIPTION

An embodiment of the invention includes a night light that may be applied to hang on and illuminate a door knob. The night light may glow red and include a power source consisting of a battery pack that powers the red light. The battery pack can be recharged and can also be used as an emergency charging device for a mobile phone or other low voltage device. To conserve battery life this invention may also incorporate a photo cell that will shut the illumination lights off when the ambient light is sufficient and will turn on when ambient light is lacking. The device (also referred to herein as an “article”) comprises a loop shaped light emitting portion. The looped shape has a size that allows it to fit over a standard sized door knob. The device includes an on/off toggle switch, as well as an automatic photocell circuit. The circuit provides power for light emitting diodes (LEDs) located at either end of the illumination portion, which light the entire loop. The body of the device houses the circuitry and battery pack and may also include a charging port to enable the battery back to be recharged via standard 5V transformer and cable without dismantling or opening the device.

To assist for the use when traveling, the device may be collapsible to a smaller, more convenient size for travel.

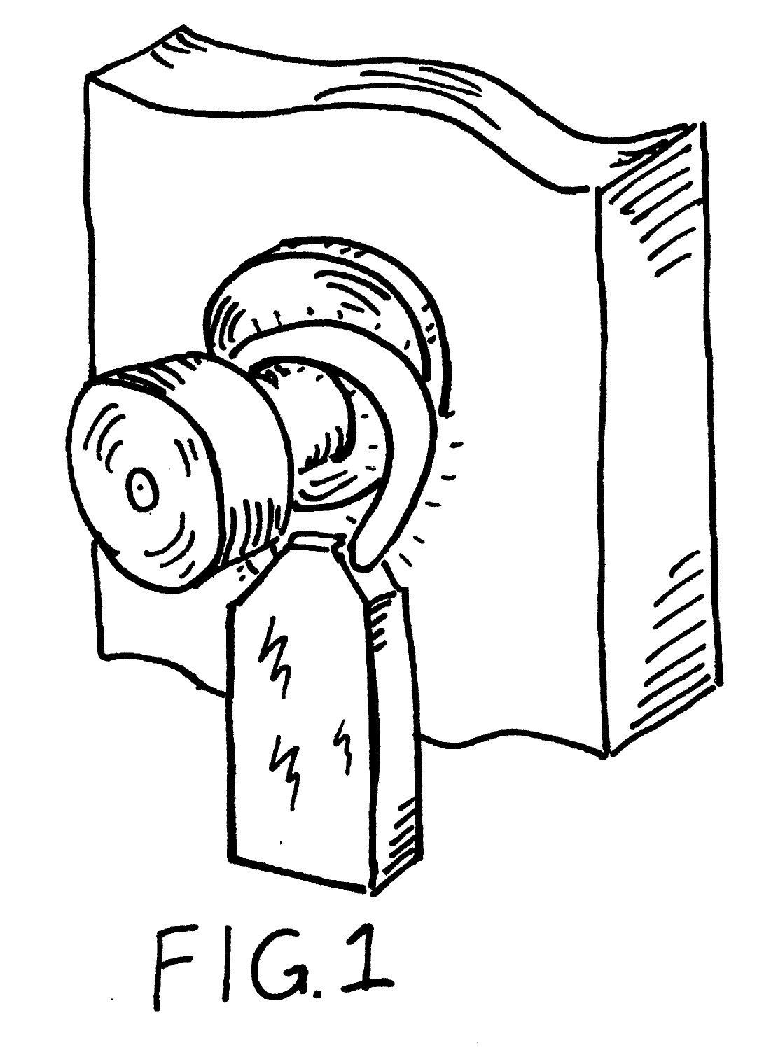

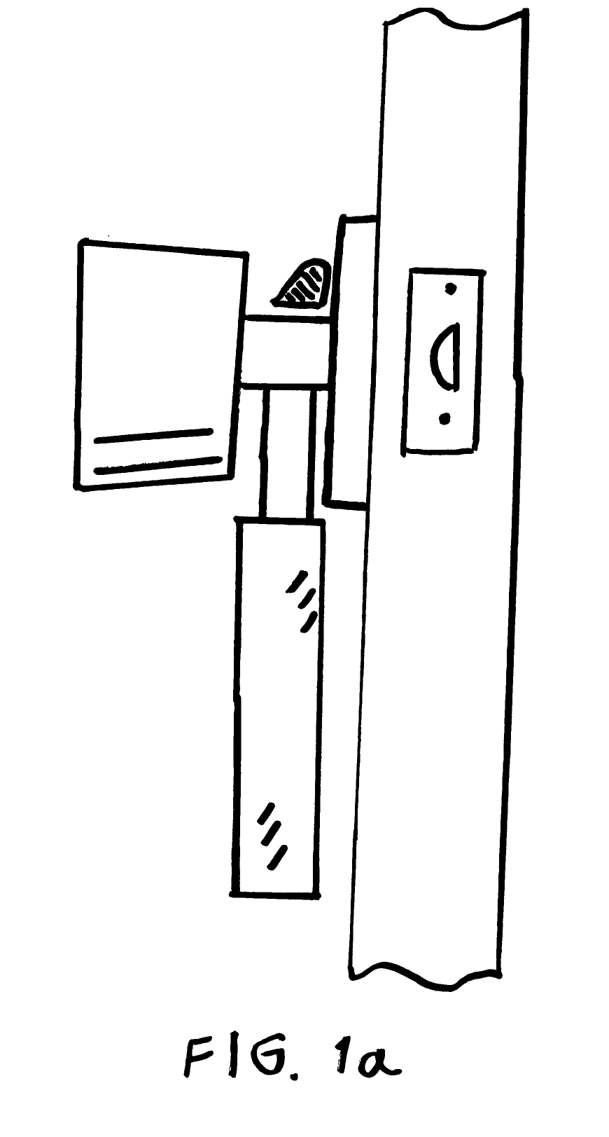

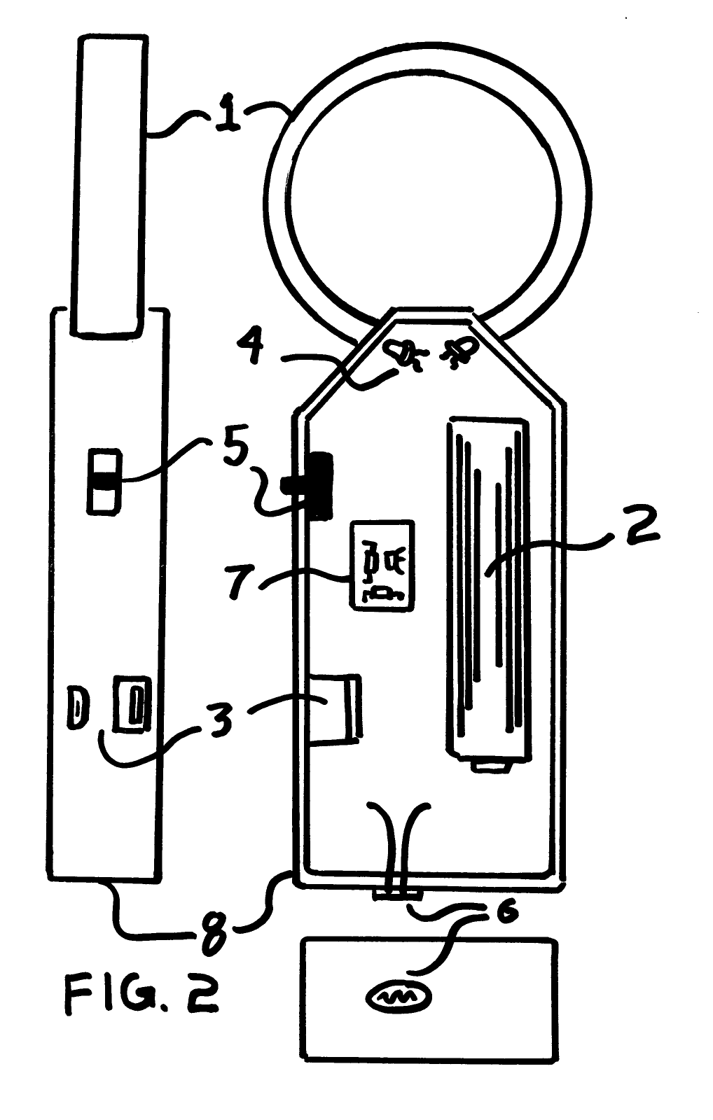

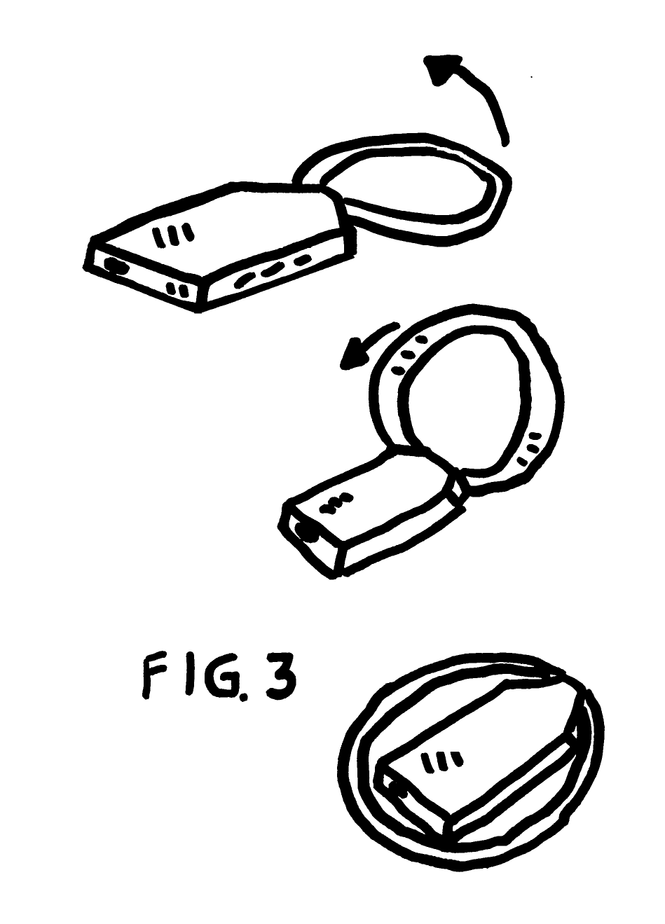

In one embodiment, as shown in FIG. 1, the invention is an article that attaches to a door knob to illuminate the dark and assist the user in orientation and locating a door knob. A side view is depicted in FIG. 1a. A typical layout of the various features and components of the device can be seen in FIG. 2. The device includes a light emitting member [1] that will emit a low intensity glow, preferably in a red hue. The light emitting member [1] may be shaped in a loop, so that it can be hung on a typical door handle. The light emitting member [1] may be powered by a rechargeable battery pack [2], such as a lithium ion battery pack. The battery pack [2]may be externally charged and discharged via a charging port [3]. In some examples, the charging port [3] may be a universal serial bus (USB) charging port [3]. The battery pack [2] powers one or more light emitting diodes (LED) [4] that illuminate the light emitting member [1]. In order to transmit the light from the LEDs [4], the light emitting member [1] may be constructed of an acrylic or translucent material. Power to the LEDs [4]may be controlled by an analog toggle switch [5] in conjunction with a photo cell [6] wired to a circuit board [7] with resistors and transistors. As would be appreciated by one of skill in the art, the circuitry [7] is configured for the photo cell [6] to enable the LED to activate when ambient light decreases beneath a predetermined level, such as an ambient level of about less than 100 lux. Beneath such levels, the light emitting member [1] illuminates in response to the analog switch being in the “on” position. The prior stated components [2-7] that support the light emitting member may be contained in a housing [8]. To support compact portability and light projection off of a horizontal surface, the light emitting member [1] and housing [8] may be constructed in a manner to enable the light emitting member [1] to pivot or collapse to different positions and enclose the housing as depicted in FIG. 3 to result in a reduced volume for enhanced portability.

A common application of the device may involve being hung on a door knob. With the power switch in the “on” position the device will illuminate with a low intensity glow as the room darkens. A red hue may be preferable, as it can reduce ocular discomfort to dilated eyes. Accordingly the glowing light emitting member [1] will provide the user quick orientation to where the desired door handle and door is in the room. The device could assist youth and elderly in locating the bathroom door in a dark room or a dark hall way. This invention could be very useful for people in new environments where orientation may not be automatic, such as hotel rooms where ambient light can be very low due to light blocking window currents.

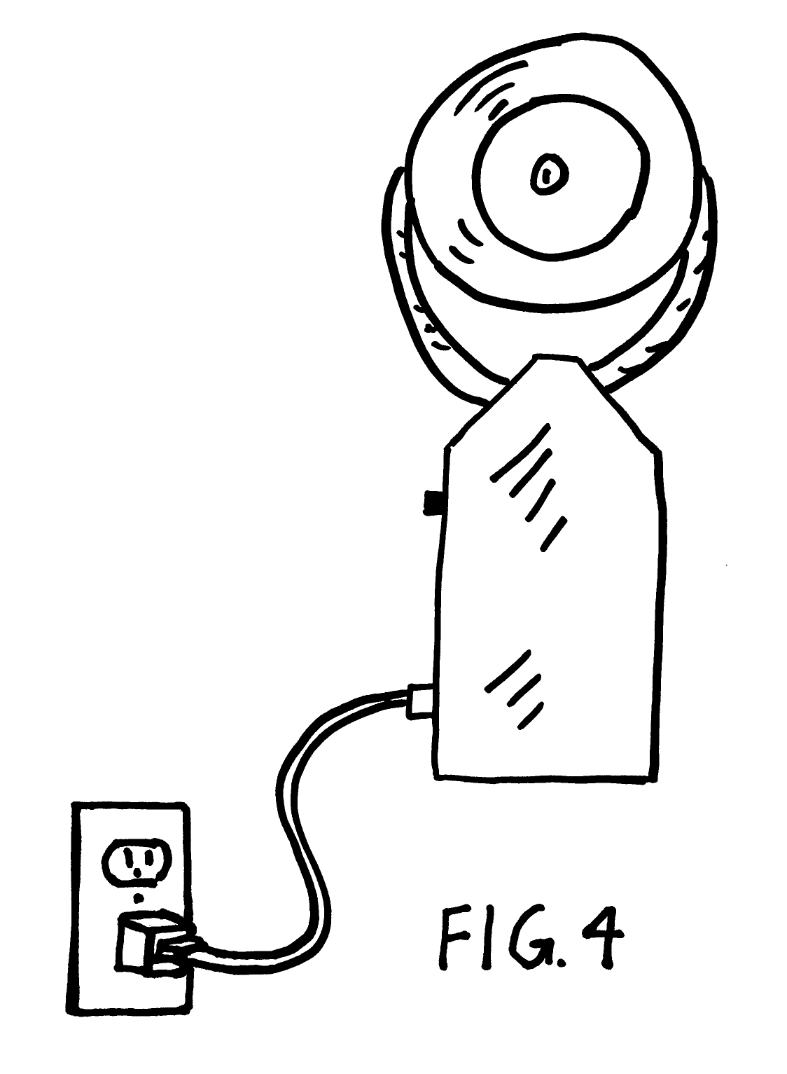

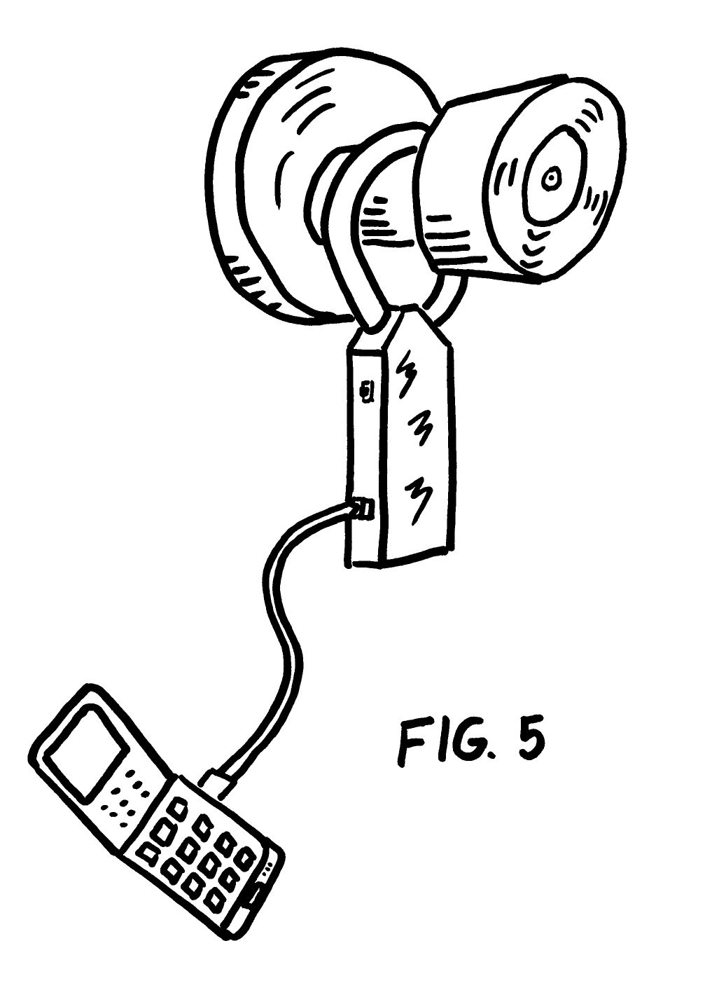

Other applications may involve using the device as a table top or bed stand night light when the light emitting member [1] is pivoted as shown in FIG. 3. The USB charging port [3] may also enable the user to utilize external power, such as a hard wired power supply by a AC to DC transformer to power the illuminating device, as depicted in FIG. 4. Additionally the internal power supply battery pack [2] could be utilized with the illuminating device at the same time for charging or powering other low voltage DC electronic devices as shown in FIG. 5.

1. An illuminating device for door knobs, comprising a light emitting member formed into a circular loop shape, the circular loop shape emitting a low intensity glow.

2. The illuminating device as described in claim 1, wherein the circular loop shape is sized to hang upon the door knob.

3. The illuminating device as described in claim 1, wherein the illumination produces a light in a red hue.

4. The illuminating device as described in claim 1, wherein the illuminating device is collapsible by various means resulting in a reduced volume occupied by said device.

5. The illuminating device as described in claim 1, comprising a rechargeable power source and at least one of an external charge port and an external discharge port.

6. The illuminating article as described in claim 1, comprising an illumination sensor that will allow said light emitting member to illuminate in response to ambient light conditions being below a predetermined level.
